(19) United States
(12) Patent Application Publication
(10) Pub. No.: US 2024/0393114 A1
(43) Pub. Date: Nov. 28, 2024

(54) SYMMETRIC DIFFERENTIAL TRANSDUCER

(71) Applicant: Murata Manufacturing Co., Ltd., Nagaokakyo-shi (JP)

(72) Inventor: Mikko PARTANEN, Vantaa (FI)

(21) Appl. No.: 18/666,639

(22) Filed: May 16, 2024

(30) Foreign Application Priority Data
May 22, 2023 (EP) 23174564.7

(51) Int. Cl. G01C 19/5712; G01P 15/125

(52) U.S. Cl. CPC G01C 19/5712; G01P 15/125

(57) ABSTRACT

A microelectromechanical device is provided that includes a first proof mass and a second proof mass in a device plane. The first proof mass includes a first set of rotor combs, and the first set of rotor combs comprises a first set of rotor transducer combs. The second proof mass includes a second set of rotor combs, and the second set of rotor combs comprises a second set of rotor transducer combs. The first and second proof masses are configured to undergo anti-phase movement. The first set of rotor combs also includes a first set of dummy rotor combs and the second set of rotor combs also includes a second set of dummy rotor combs. The first set of rotor combs is reflection-symmetric with the second set of rotor combs.

### CROSS REFERENCE TO RELATED APPLICATIONS

This application claims priority to European Patent Application No. 23174564.7, filed May 22, 2023, the entire contents is hereby incorporated by reference in their entirety.

### TECHNICAL FIELD

This disclosure relates to microelectromechanical devices, and more particularly to capacitive for transducers which can be utilized to drive or measure the motion of mass elements. The present disclosure also concerns the symmetry of mass elements.

### BACKGROUND

Microelectromechanical (MEMS) devices such as accelerometers and gyroscopes can measure acceleration and angular rotation rate by monitoring how small mobile proof masses move in relation to a surrounding fixed structure. Proof masses may be called rotors, and fixed structures may be called stators.

The movement of a proof mass is often measured with capacitive force transducers constructed in and around the proof masses. In gyroscopes, capacitive force transducers can also be used to drive the proof masses into continuous oscillating motion.

Proof masses must be suspended from surrounding fixed structures with flexible suspenders. These suspenders allow the masses to move in relation to the fixed structures when the device undergoes acceleration or angular rotation. However, a general problem in microelectromechanical (MEMS) accelerometers and gyroscopes is that proof masses-since they are flexibly suspended—may also be set in motion by external disturbances which are not intended to be measured. For example, a MEMS sensor which is intended to measure the movement of a vehicle may erroneously register the mechanical vibrations of the vehicle body as vehicle movement.

It is known that the influence of external disturbances can be mitigated by using devices where two proof masses move in anti-phase and a differential force transducer measures the anti-phase movement. The two proof masses move in opposite directions in anti-phase movement. In this arrangement, signal components arising from cophasal disturbances (which shift both proof masses in the same direction) are to some degree automatically cancelled in the measurement.

FIG. 1 illustrates a gyroscope with a differential force transducer. The principles of differential measurement are the same in accelerometers, as explained later in this disclosure. The gyroscope in FIG. 1 comprises proof masses 11 and 12 which move in anti-phase toward and away from a central axis 15, as arrows 17 illustrate. The gyroscope may comprise a synchronization structure (not illustrated) which couples proof mass 11 to 12 to each other so that 11 moves to the right when 12 moves to the left, and vice versa. The gyroscope also comprises first and second fixed structures 191 and 192.

A differential capacitive transducer can be constructed by shaping the first proof mass 11 so that it comprises a first set 111 of rotor finger electrodes and shaping the second proof mass 12 so that it comprises a second set 121 of rotor finger electrodes. A set of first (181) and second (182) stator finger electrodes are formed on the fixed structures 191 and 192 so that they are interdigitated with the first (111) and second (121) sets of rotor electrodes. Electrodes 111+181 form a first capacitor while electrodes 121+182 form a second capacitor. The differential transducer comprises both of these capacitors. MEMS proof masses are typically made of silicon, a semiconductive material. This allows the proof mass itself to be used as a capacitor electrode.

A differential transducer is obtained by designing the two capacitors so that their signals have equal magnitude as a function of proof mass displacement, but different polarities. In other words (using the illustrated motion phase 17 as an example), if the transducer is used as a sense transducer, the capacitance increases in the first capacitor 111 and 181 when the first proof mass 11 moves to the right (due to increasing overlap between fingers). The second proof mass 12 moves simultaneously to the left since the masses move in anti-phase, and the capacitance decreases in the second capacitor 121 and 182 (due to decreasing overlap). Subtracting the capacitance of the first capacitor from the capacitance of the second capacitor yields a differential signal which increases when the two masses simultaneously move toward the central axis 15 and decreases when they simultaneously move away from the axis. The differential capacitive transducer generates this signal. The automatic error cancellation occurs because the two capacitive signals have opposite polarity. Co-phasal disturbances increase capacitance in one of the capacitors but decrease it in the other. This increase and decrease will ideally cancel each other in the differential signal.

The measurement described above is only one example. The same differential principle can be utilized to accurately measure movement in many directions (in the device plane and out of the device plane), with any number of proof masses (systems with two, four or eight masses, for example), and in many different geometries. The particular disturbance that a given differential measurement can cancel depends on device design. Differential transducers can be used as drive transducers in some devices.

However, differential transducers share a common problem: capacitors of opposite polarity can typically only be obtained with proof mass designs which are asymmetric with respect to the central axis 15.

The problem is elucidated in the example illustrated in FIG. 1, where we may focus on the geometry of the first proof mass 11 in region 161 and the geometry of the second proof mass 12 in region 162. In order to achieve the polarity difference described above, rotor finger electrodes must lie on the same side (left side in FIG. 1) of stator finger electrodes in both the first and the second capacitors. Proof masses 11 and 12 can therefore not be reflection-symmetric with respect to the axis 15. If combs 111 and 121 (and thereby proof masses 11 and 12) would be made reflection-symmetric with respect to 15, then the illustrated anti-phase motion 17 would yield signals with equal polarity. No differential transducer could then be constructed.

This lack of reflection-symmetry between proof masses 11 and 12 in FIG. 1, and in other conventional art devices, means that the moments of inertia of the two masses 11 and 12 with respect to axis 15 will not be equal. The two masses may for this reason respond differently to some external linear and angular vibrations, which can lead to measurement errors. In theory, the moments of inertia could be equalized by keeping the electrodes 111 and 121 as they are but changing the other dimensions of one or both proof masses. However, it is in practice difficult to perform this kind of balancing without introducing other errors to the measurement.

### SUMMARY OF INVENTION

In view of the foregoing, it is an object of the present disclosure to provide a device that alleviates the above disadvantages. The disclosure is based on the idea of building on the proof mass dummy combs which have no measurement function. The combs structures are configured to be made symmetric with a suitable placement of these dummy combs.

In some aspects, the techniques described herein relate to a microelectromechanical device including: a first proof mass and a second proof mass in a device plane; and a first axis in the device plane, and two fixed stator elements; wherein the first proof mass lies on a first side of the first axis and includes a first set of rotor combs, and the first set of rotor combs includes a first set of rotor transducer combs, the second proof mass lies on a second side of the first axis and includes a second set of rotor combs, and the second set of rotor combs includes a second set of rotor transducer combs, and the first side and the second side of the first axis are opposite to each other, the two fixed stator elements include a first set of stator transducer combs which is interdigitated with the first set of rotor transducer combs, wherein the first set of rotor transducer combs and the first set of stator transducer combs form a first capacitor on the first side of the first axis, the two fixed stator elements also include a second set of stator transducer combs which is interdigitated with the second set of rotor transducer combs, wherein the second set of rotor transducer combs and the second set of stator transducer combs form a second capacitor on the second side of the first axis, and the first proof mass and the second proof mass are configured to undergo an anti-phase movement, wherein the first proof mass moves in a first direction on the first side of the first axis and the second proof mass moves in a second direction on the second side of the first axis, and the first direction is opposite to the second direction, the first set of rotor combs further include a first set of dummy rotor combs and the second set of rotor combs further include a second set of dummy rotor combs, and the first set of rotor combs is reflection-symmetric with the second set of rotor combs in relation to the first axis.

In some aspects, the techniques described herein relate to a microelectromechanical device including: a first proof mass and a second proof mass in a device plane; a third proof mass and a fourth proof mass in the device plane; a first axis in the device plane and a second axis in the device plane, the second axis is perpendicular to the first axis and crosses the first axis at a crossing point; and four fixed stator elements; wherein the first proof mass lies on a first side of the first axis and includes a first set of rotor combs, and the first set of rotor combs includes a first set of rotor transducer combs, the second proof mass lies on a second side of the first axis and includes a second set of rotor combs, and the second set of rotor combs includes a second set of rotor transducer combs, the first side and the second side of the first axis are opposite to each other, the third proof mass lies on a first side of the second axis and includes a third set of rotor combs, and the third set of rotor combs includes a third set of rotor transducer combs, the fourth proof mass lies on a second side of the second axis and includes a fourth set of rotor combs, and the fourth set of rotor combs includes a fourth set of rotor transducer combs, the first side and the second side of the second axis are opposite to each other, the first proof mass and the second proof mass are configured to undergo an anti-phase movement, wherein the first proof mass moves in a first direction on the first side of the first axis and the second proof mass moves in a second direction on the second side of the first axis, and the first direction is opposite to the second direction, the first set of rotor combs further include a first set of dummy rotor combs and the second set of rotor combs further include a second set of dummy rotor combs, and the first set of rotor combs is reflection-symmetric with the second set of rotor combs in relation to the first axis; the third proof mass and the fourth proof mass are configured to undergo the anti-phase movement, wherein the third proof mass moves in a first direction on the first side of the second axis and the fourth proof mass moves in a second direction on the second side of the second axis, and the first direction is opposite to the second direction, and the third set of rotor combs also includes a third set of dummy rotor combs and the fourth set of rotor combs also includes a fourth set of dummy rotor combs, and the first, second, third and fourth proof sets of rotor combs are point-symmetric in relation to the crossing point.

### BRIEF DESCRIPTION OF DRAWINGS

In the descriptions that follow, like parts are marked throughout the specification and drawings with the same numerals, respectively. The drawings are not necessarily drawn to scale and certain drawings may be shown in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1 illustrates a conventional gyroscope;

FIG. 2 illustrates a microelectromechanical device with two proof masses in accordance with exemplary aspects of the present disclosure; and

FIGS. 3a-3f illustrate aspects where the anti-phase movement is rotation out of the device plane in accordance with exemplary aspects of the present disclosure.

### DETAILED DESCRIPTION

This disclosure describes a microelectromechanical device that comprises a first proof mass and a second proof mass in a device plane. A first axis is in the device plane. The device also comprises two or more fixed stator elements.

The first proof mass lies on a first side of the first axis and comprises a first set of rotor combs. The first set of rotor combs comprises a first set of rotor transducer combs. The second proof mass lies on a second side of the first axis and comprises a second set of rotor combs. The second set of rotor combs comprises a second set of rotor transducer combs. The first and second sides of the first axis are opposite to each other.

The two or more fixed stator elements comprise a first set of stator transducer combs which is interdigitated with the first set of rotor transducer combs, so that the first set of rotor transducer combs and the first set of stator transducer combs form a first capacitor on the first side of the first axis.

The two or more fixed stator elements also comprise a second set of stator transducer combs which is interdigitated with the second set of rotor transducer combs, so that the second set of rotor transducer combs and the second set of stator transducer combs form a second capacitor on the second side of the first axis.

The first and second proof masses are configured to undergo anti-phase movement, wherein the first proof mass moves in a first direction on the first side of the first axis and the second proof mass moves in a second direction on the second side of the first axis, and the first direction is opposite to the second.

The first set of rotor combs also comprises a first set of dummy rotor combs and the second set of rotor combs also comprises a second set of dummy rotor combs. The first set of rotor combs is reflection-symmetric with the second set of rotor combs in relation to the first axis.

The microelectromechanical device may be an accelerometer. Alternatively, the microelectromechanical device may be a gyroscope. The first and second proof masses may be physically separated proof masses which are configured to move in opposite directions. In this disclosure the term “proof mass” refers to a body which is rigid, at least in comparison to its suspenders. A proof mass therefore moves as a single body.

In this disclosure the device plane is illustrated and referred to as the xy-plane. The device plane is determined by the device layer. The z-axis, which may be called the vertical axis, is perpendicular to the xy-plane. In this disclosure, the term “vertical”, and related terms such as “top” and “bottom”, refer only to a direction which is perpendicular to the device plane. They do not imply anything about how the device should be orientated during manufacturing or use.

The center of gravity of each proof mass may lie in the device plane when the proof mass is in its rest position. The proof mass in its rest position when accelerometer isn't experiencing any acceleration or gravitational pull.

Motion where the center of gravity of a proof mass moves in the z-direction may be referred to as out-of-plane motion, or motion out of the device plane. This motion may for example be linear translation in the z-direction. The entire proof mass moves in the same direction in linear translation.

The proof mass may alternatively undergo rotational motion, where it rotates about an axis. Motion where the proof mass undergoes rotation about an axis in the device plane, so that one end of the proof mass moves in a positive z-direction while the other moves in a negative z-direction, is also out-of-plane motion. The center of gravity may remain in the device plane in this rotational out-of-plane motion, or it may move out of the device plane.

Motion where the center of gravity of a proof mass moves in the xy-plane, or where the proof mass rotates about a vertical axis, may be referred to as in-plane motion, or motion in the device plane.

The reflection-symmetry described in this disclosure may be reflection-symmetry with respect to the first axis or reflection-symmetry with respect to a vertical plane which comprises the first axis.

FIG. 2 illustrates a microelectromechanical device with a first proof mass 21 and a second proof mass 22. The device comprises a first axis 25. The first proof mass 21 is connected to the second proof mass 22 with a connecting part 26.

The connecting part 26 may be a flexible coupling spring which allows the masses to move in opposite directions. The coupling spring may synchronize the anti-phase movement of the two proof masses, as described in more detail below.

In aspects described in this disclosure, both the first (21) and the second (22) proof masses may be connected to an adjacent fixed structure with an at least partly flexible suspension structure which allows the first/second proof mass (21/22) to move with respect to the fixed structure. In other words, the suspension structure may extend from the fixed structure to the corresponding proof mass.

Such suspension structures are not illustrated in the Figures of this disclosure. Suspension structures may comprise springs which flexibly allow the suspended proof mass to move in a certain way but rigidly resist proof mass movement in another direction. For example, the suspension structure may allow linear translation in the x-direction but resist all out-of-plane movement (in the z-direction). Alternatively, the suspension structure may allow rotation out of the device plane (in the z-direction) but resist linear translation in the xy-plane.

The first proof mass 21 comprises a first set of rotor combs. This set includes a first set of rotor transducer combs 211 and a first set of dummy rotor combs 212. Correspondingly, the second set of rotor combs, which is on the second proof mass 22, comprises a second set of rotor transducer combs 221 and a second set of dummy rotor combs 222.

The two or more fixed stator elements may comprise at least one first fixed stator element which is adjacent to the first proof mass, and at least one second fixed stator element which is adjacent to the second proof mass. The first proof mass then forms the first capacitor together with the first fixed stator element, and the second proof mass forms the second capacitor together with the second fixed stator element. The device illustrated in FIG. 2 comprise two first fixed stator elements 291 and two second fixed stator elements 292. Even though four fixed stator elements are illustrated in FIG. 2, any other number could be selected depending on the device geometry. There could for example be one first fixed stator element which is adjacent to the first proof mass 21 and one second fixed stator element which is adjacent to the second proof mass 22.

The first fixed stator elements 291 which are adjacent to the first proof mass 21 comprise a first set of stator transducer combs 281. The second fixed stator elements 292 which are adjacent to the second proof mass 22 comprise a second set of stator transducer combs 282.

The device layer may be a device wafer, for example a silicon wafer. Alternatively, the device layer may be a layer which has been deposited on a substrate. The device layer may also be called a structural layer. The device layer may be a silicon layer.

The device layer comprises fixed parts which are immobile in relation to the surrounding device package. The device layer also comprises parts which are mobile in relation to the device package and the fixed parts. These mobile parts include proof masses and flexible suspenders which attach the proof masses to fixed parts.

The micromechanical structures which form the mobile parts are configured to be prepared in the device layer by etching the layer. When the structures are completed, the fixed parts of the device layer may form a supporting body which surrounds the mobile parts in the device plane. The device layer itself may be structurally supported by a separate, thicker support wafer or substrate during manufacturing and/or in the finished accelerometer. The support wafer may be called a handle wafer.

The word “proof mass” refers in this disclosure to a mobile part which is formed in the device layer. The proof masses described in this disclosure may for example be made of silicon. The movement of the proof mass in response to a force is determined by the direction and magnitude of the force, by the flexible properties of the suspenders, and by the size/weight of the proof mass. If multiple proof masses are coupled together, the movement will also be determined by the properties of the coupling springs which join the proof masses to each other.

The proof mass may alternatively be called a rotor, and a fixed structure which is adjacent to the proof mass may be called a stator. This terminology is used in this disclosure to distinguish between capacitor combs formed on the mobile proof mass (rotor combs) and capacitor combs formed on an adjacent fixed structure (stator combs).

As illustrated in FIG. 2, the first set of rotor transducer combs 211 form a first capacitor 241 together with the first set of stator transducer combs 281. Correspondingly, the second set of rotor transducer combs 221 form a second capacitor 242 together with the second set of stator transducer combs 282.

In aspects in this disclosure, the first and second capacitors may be measurement capacitors. Alternatively, the first and second capacitors may be force-generating capacitors. The first and second capacitors may together form a differential transducer. This transducer may be configured to drive the first and second proof masses into the anti-phase movement if the capacitors are used for force-generating purposes. If they are used for measurement purposes, then the differential transducer may be configured to measure the anti-phase movement of the proof masses.

Optionally, in addition to the anti-phase movement, the first and second proof masses may be configured to undergo also other movement which is not anti-phase. The two proof masses could for example be configured to move simultaneously (common phase) in the y-direction even as they oscillate in anti-phase in the x-direction. The microelectromechanical device may comprise additional capacitive transducers for driving or measuring this other movement. These additional capacitive transducers may comprise additional rotor combs on the first and second proof masses. These additional rotor combs may be symmetric with respect to the first axis in the same way that the first and second sets of rotor combs are.

The fixed stator elements 291-292, and stator transducer combs 281-282, may in some devices be formed in the fixed parts of the device layer. However, they may in other devices be formed in some other fixed structure which is adjacent to the device layer. The first and second proof masses 21-22, and the rotor transducer combs 211-221 and rotor dummy combs 212-222 which form a part of the proof masses, are formed in the device layer. Rotor transducer combs 211-221 are interdigitated with stator transducer combs 281-282 in the device plane, as FIG. 2 illustrates. Rotor dummy combs 212-222 are not interdigitated with stator combs.

If the first and second proof masses are made of a semiconductive material such as silicon, then all parts of the first proof mass 21 are at the same electric potential and all parts of the second proof mass 22 are also at the same electric potential. The first and second proof masses may be in direct electrical contact with each other, so that the electric potential of the first and second proof masses 21 and 22 is equal. The first fixed stator elements 291 and the second fixed stator elements 292 may, on the other hand, be electrically separated from each other, so that the two capacitive measurements performed in capacitors 241 and 242 are independent of each other.

The same considerations apply to all aspects presented in this disclosure. In other words, all proof masses (and the combs they include) in any microelectromechanical device described in this disclosure may be at the same electric potential. The stator elements (and the combs they include) which are connected to different proof masses may be electrically separated from each other so that a distinct capacitor is formed at each proof mass.

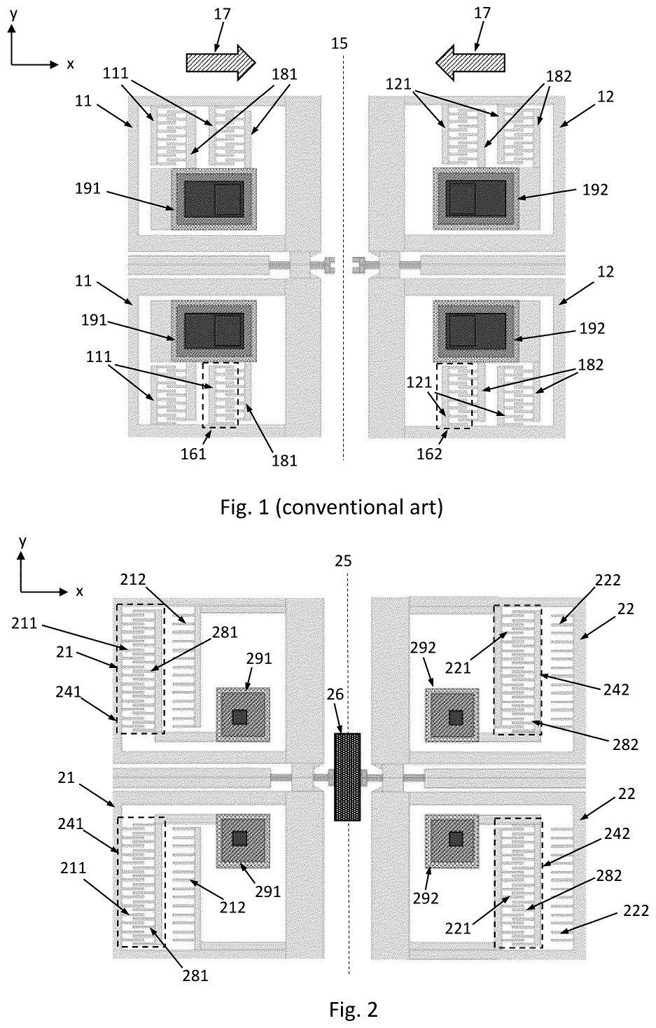

As illustrated in FIG. 2, in the case of anti-phase linear movement such as 17 in FIG. 1, the first and second capacitors 241 and 242 have opposite polarity. The capacitance of 241 increases when the capacitance of 242 decreases, and vice versa. This polarity is obtained through the asymmetric shape of the first and second proof masses 21 and 22, as explained above with reference to FIG. 1.

However, the presence of the dummy rotor combs 212 and 222 on the first and second proof masses, respectively, makes the device in FIG. 2 different from the one in FIG. 1. As illustrated, the addition of the dummy rotor combs 212 and 222 to the first and second sets of rotor combs makes these sets reflection-symmetric with respect to the first axis 25. This is because both sets of rotor dummy combs 212 and 222 point in a direction which is opposite to the direction in which rotor transducer combs 211 and 221 point. The first set of rotor dummy combs 212 is reflection-symmetric with the second set of rotor transducer combs 221, while the second set of rotor dummy combs 222 is reflection-symmetric with the first set of rotor transducer combs 211.

In FIG. 2 the first proof mass 21 in its entirety is also reflection-symmetric with the entirety of the second proof mass 22. The entirety of the first proof mass (including all combs) may be reflection-symmetric with the entirety of the second proof mass in relation to the first axis. This applies to all aspects in this disclosure.

The rotor dummy combs 212 and 222 are not interdigitated with any stator combs, and therefore they do not form a part of any capacitor. The dummy combs therefore have no electrical function in the microelectromechanical device. They only provide symmetry, and thereby mechanical balancing.

Various options relating to the number of proof masses and the type of anti-phase movement are presented below. It should be noted that the differential transducer which is formed by the first and second capacitors are configured to perform different functions. In gyroscopes, it may for example be utilized as a drive transducer which sets proof masses into primary oscillation motion. Alternatively, it may be used as a drive-sense transducer which measures the primary oscillation motion driven by a drive transducer. Another alternative is that it may be used as a sense transducer which measures the secondary oscillation motion caused by the Coriolis force. In accelerometers, the differential transducer may be used as a sense transducer which measures proof mass movement caused by acceleration. The benefits of symmetry are the same regardless of the function.

Four proof masses are illustrated in some aspects. The symmetry which was discussed in detail with reference to FIG. 2 can be implemented in relation to two different axes in these aspects.

In addition to the parts which were discussed above with reference to FIG. 2, in four-mass aspects the device also comprises a third proof mass and a fourth proof mass in the device plane and a second axis in the device plane. The device also comprises two or more additional fixed stator elements. The second axis is perpendicular to the first axis and crosses the first axis at a crossing point.

The third proof mass lies on a first side of the second axis and comprises a third set of rotor combs. The third set of rotor combs comprises a third set of rotor transducer combs.

The fourth proof mass lies on a second side of the second axis and comprises a fourth set of rotor combs. The fourth set of rotor combs comprises a fourth set of rotor transducer combs. The first and second sides of the second axis are opposite to each other.

The two or more additional fixed stator elements comprise a third set of stator transducer combs which is interdigitated with the third set of rotor transducer combs, so that the third set of rotor transducer combs and the third set of stator transducer combs form a third capacitor on the first side of the second axis.

The two or more additional fixed stator elements also comprise a fourth set of stator transducer combs which is interdigitated with the fourth set of rotor transducer combs, so that the fourth set of rotor transducer combs and the fourth set of stator transducer combs form a fourth capacitor on the second side of the second axis.

The third and fourth proof masses are configured to undergo anti-phase movement, wherein the third proof mass moves in a first direction on the first side of the second axis and the fourth proof mass moves in a second direction on the second side of the second axis, and the first direction is opposite to the second.

The third set of rotor combs also comprises a third set of dummy rotor combs and the fourth set of rotor combs also comprises a fourth set of dummy rotor combs, and the first, second, third and fourth sets of rotor combs may be point-symmetric in relation to the crossing point.

Alternatively, the third and fourth sets of rotor combs may be mirror-symmetric in relation to the second axis. The entirety of the third proof mass may be reflection-symmetric with the entirety of the fourth proof mass in relation to the second axis.

The anti-phase movement may be linear translation in the device plane, for example the kind that arrows 17 illustrate in FIG. 1.

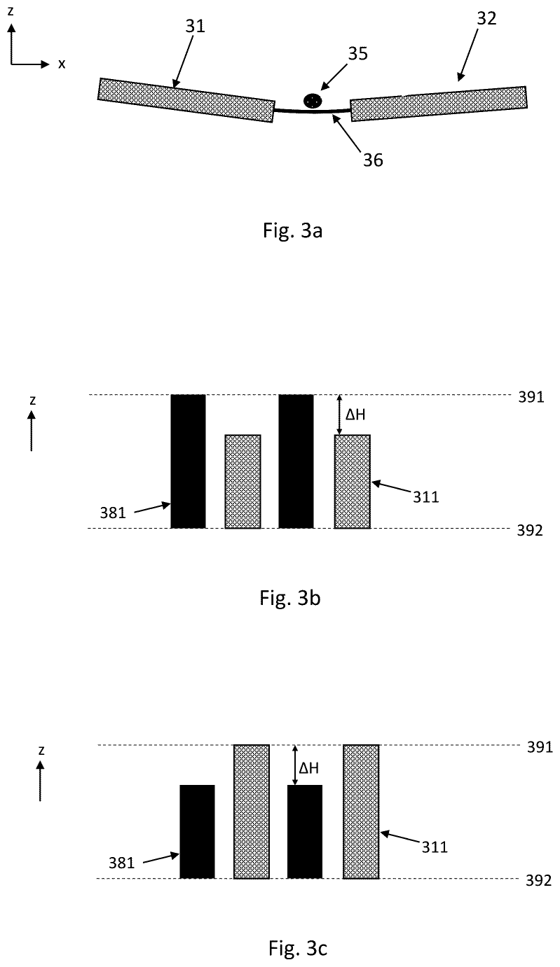

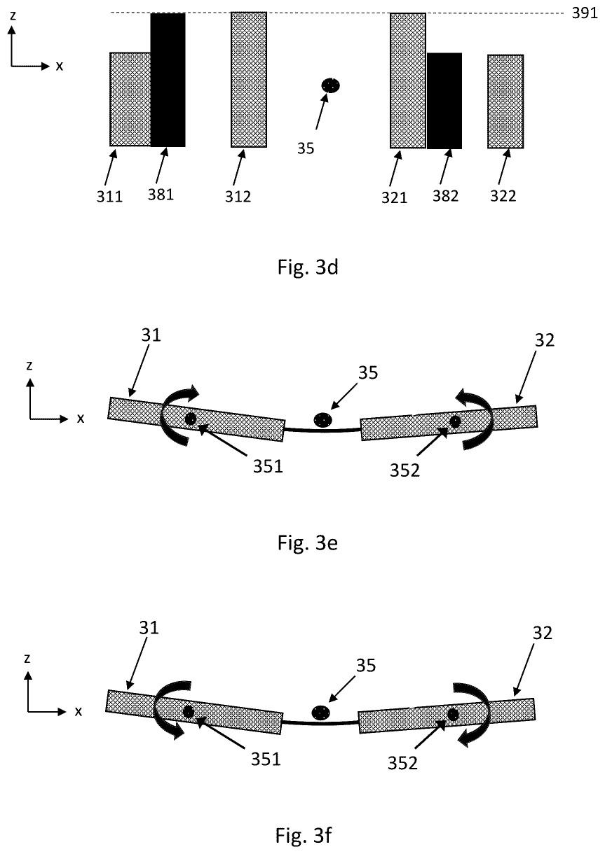

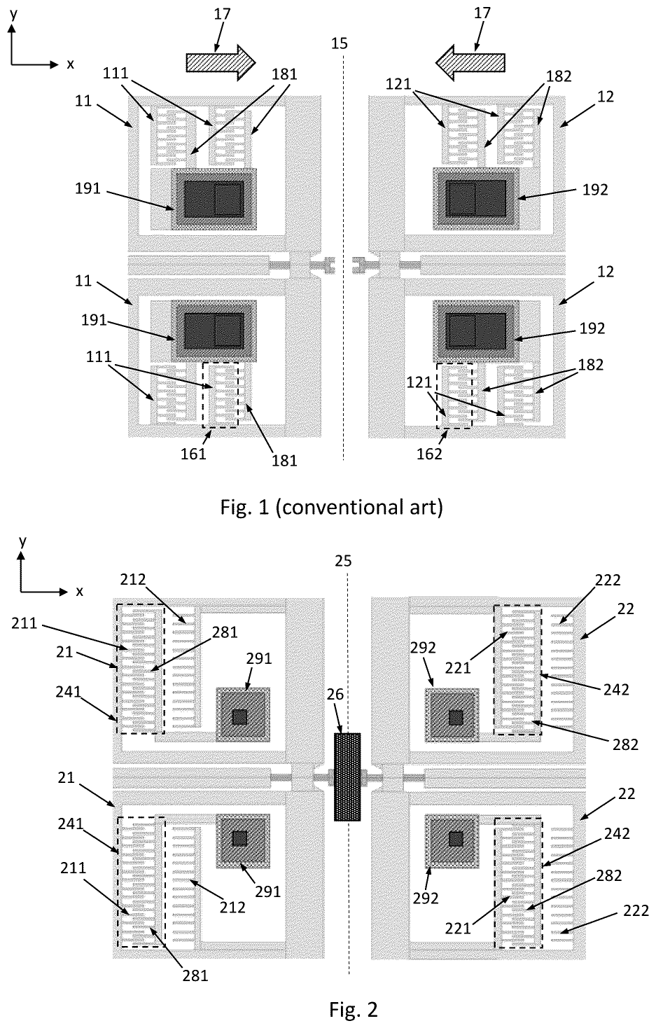

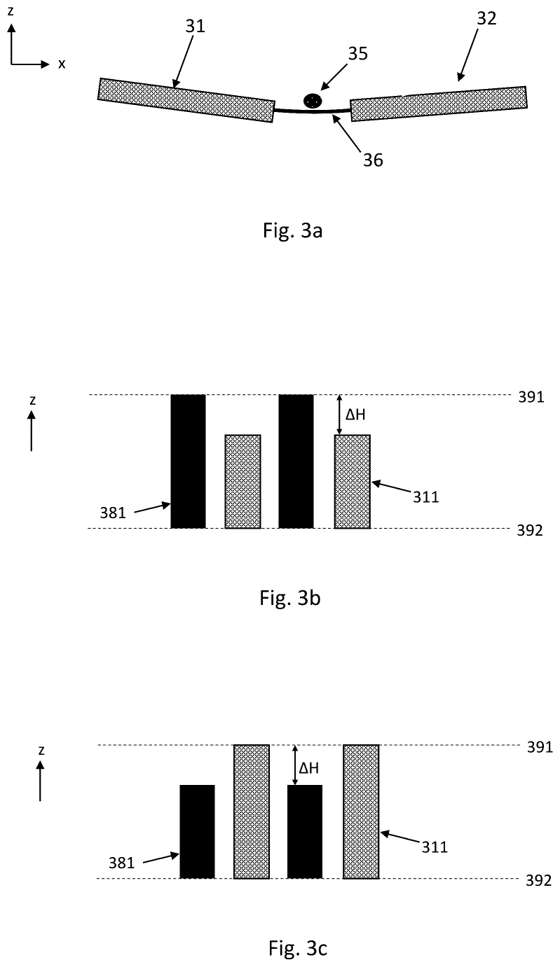

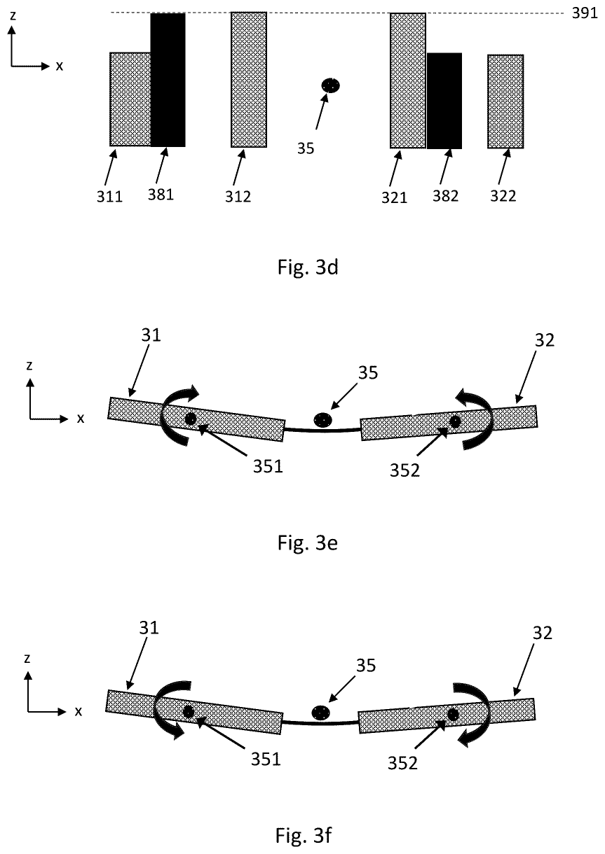

Alternatively, the anti-phase movement may be rotation out of the device plane. This rotation may be oscillating back-and-forth movement. This kind of movement is illustrated in FIG. 3a, where reference numbers 31, 32, 35 and 36 correspond to reference numbers 21, 22, 25 and 26, respectively, in FIG. 2. The first and second proof masses 31 and 32 may for example be suspended with their respective suspension structures so that acceleration in the z-direction rotates them as FIG. 3a illustrates. Alternatively, the illustrated anti-phase movement could be generated by a drive transducer which sets the two masses into oscillating anti-phase motion, or it could be caused by the Coriolis force when the device undergoes angular rotation.

The connecting part 36 may be a bendable spring which allows the first and second proof masses 31 and 32 to rotate in opposite out-of-plane directions. The connecting part 36 may bend flexibly in the out-of-plane direction, as FIG. 3a illustrates. The connecting part 36 may also synchronize the anti-phase motion of the first and second proof masses 31 and 32.

The first and second sets of rotor combs on the first and second proof masses C1 and C2 may be oriented as FIG. 2 illustrates, but many other orientations are also possible. Out-of-plane movement may be measured with rotor and stator combs which are interdigitated in the xy-plane. However, the rotor combs should in this case be recessed in the vertical (z) direction in relation to the stator combs, or vice versa.

This may be explained with reference to FIGS. 3b-3c. which illustrate a vertical cross-section of interdigitated rotor combs 311 and stator combs 381. Both sets of combs have been formed in the device layer. The combs may be formed by etching the device layer in the vertical direction. Top reference line 391 illustrates the vertical level of the top surface of the device layer and bottom reference line 392 illustrates the vertical level of the bottom surface of the device layer.

Rotor combs 311 have been recessed by ΔH in relation to the top reference line 391. FIG. 3b illustrates the position of the interdigitated combs when the proof mass (which comprises the rotor combs) is in its rest position. When the proof mass moves in the negative z-direction (downward in FIG. 3b), the mutual overlap between rotor combs 311 and stator combs 381 will decrease. The movement of the proof mass can therefore be registered as a capacitance change in this transducer. Proof mass movement in the positive z-direction will not change the capacitance as long as the mutual overlap remains unchanged (i.e. as long as the top side of the rotor combs 311 does not move above reference line 391). On the other hand, if the stator combs 381 are recessed, as FIG. 3c shows, then rotor movement in the positive direction will reduce the capacitance but movement in the negative direction will keep the capacitance unchanged.

Movement in the positive direction should be distinguishable from movement in the negative direction in every transducer. Movement in both of these directions can be monitored by implementing the recessing shown in FIG. 3b in some transducers, and the recessing shown in FIG. 3c in other transducers. Any combination of such transducers are configured to be included in differential measurement configurations. Furthermore, transducers with recessed combs are configured to also be used to generate a driving force in the z-direction. A voltage applied between the rotor and stator combs in FIG. 3d will drive the proof mass upward, while a voltage applied between the combs in FIG. 3c will drive the proof mass downward.

Double-sided recessing, where the bottom side of the rotor or stator combs is also offset from the corresponding bottom reference line 392, is also possible. This option has not been illustrated.

The anti-phase rotation illustrated in FIG. 3a can be measured or driven with differential transducers where the first set of rotor combs (on the first proof mass 31), is reflection-symmetric with the second set of rotor combs (on the second proof mass 32) in relation to the first axis 35. This could be implemented in many different ways. As in the preceding in-plane aspect, the main idea is to achieve symmetry by implementing dummy rotor combs which are not paired with any electrically active stator combs.

FIG. 3d illustrates one possible arrangement. A first set of rotor transducer combs 311 is interdigitated with a first set of stator measurement combs 381 so that they together form a first capacitor. The second set of rotor transducer combs 321 is interdigitated with a second set of stator measurement combs 382 so that they together form a second capacitor. The interdigitation has not been illustrated in FIG. 3d. Instead, FIG. 3d only illustrates which combs have been recessed, in this case from the top reference line 391, and which have not. The distance of the combs from the first axis 35 is also illustrated schematically.

As illustrated in FIG. 3d, reflection symmetry with respect to a vertical plane which comprises the first axis 35 is configured to be achieved for example by recessing the first set of rotor transducer combs 311 and the second set of rotor dummy combs 322. In the first capacitor formed by 311+381, the rotor transducer combs are recessed, while in the second capacitor 321+382 the stator transducer combs are recessed.

The recessing scheme in FIG. 3d is a very simple one, and more complicated ones can be implemented. Both the first set of rotor transducer combs 311 and the second set of rotor transducer combs 321 could for example comprise some transducer combs which have been recessed and some which have not been recessed. In general, the recessing pattern of 311 is mirrored in the recessing pattern of the second set of rotor dummy combs 322, and the recessing pattern of 321 is mirrored in the recessing pattern of the first set of rotor dummy combs 312. The rotor transducer combs 381 is configured to be recessed with a pattern which yields the desired differences illustrated in FIGS. 3b and 3c. Any recess pattern mentioned in this paragraph may include double-sided recessing.

If the anti-phase movement out of the device plane is generated by a drive transducer, then the differential transducer may be used as a drive-sense transducer which measures the primary oscillation motion driven by the drive transducer. If the movement is generated by the action of the Coriolis force in the z-direction, then the differential transducer may be used as a sense transducer which measures the secondary oscillation motion caused by the Coriolis force. If the movement is generated by acceleration in the z-direction, then the differential transducer may be used as a sense transducer which measures proof mass movement caused by acceleration in the z-direction.

When the anti-phase movement is rotation out of the device plane, the first (31) and second (32) proof masses may be configured to undergo out-of-plane rotation in opposite directions. In other words, as FIG. 3e illustrates, the first proof mass 31 may undergo rotation in a clockwise direction (about a first rotation axis 351 which is parallel to the first axis 35), when the second proof mass 32 undergoes rotation in a counterclockwise direction (about a second rotation axis 352 which is also parallel to the first axis 35). The location of the first and second rotation axes 351-352 depends on the suspension structures from which the first and second proof masses are suspended.

If the rotation is oscillating back- and forth movement, then the first proof mass 31 will, in the opposite phase of the oscillation cycle, rotate counter-clockwise as the second proof mass 32 rotates clockwise. This is illustrated in FIG. 3f. The z-coordinates of the ends of proof masses 31 and 32 which are closest to the first axis 35 lie below the z-coordinate of the first axis 35 in FIGS. 3e-3f. However, the rotation illustrated in FIG. 3f may continue so far that the ends which are closest to the first axis 35 rise to a z-coordinate which is greater than the z-coordinate of the first axis 35.

The suspension structures (not illustrated) which suspend proof masses 31 and 32 from a fixed structure may be configured to flexibly allow rotation of the first and second proof masses out of the device plane about rotation axes (such as 351 and 352) that are parallel to the y-axis. Furthermore, the suspension structures may also allow rotation of the first and second proof masses out of the device plane about rotation axes (not illustrated) that are parallel to the x-axis. The latter rotation may for example occur if the microelectromechanical device is a gyroscope and the proof masses 31 and 32 are driven in rotating primary oscillating movement about axes 351 and 352 by drive transducers. The Coriolis force may then generate rotating secondary oscillation about an axis parallel to the x-axis when the gyroscope undergoes rotation about the z-axis.

The suspension structures which suspend proof masses 31 and 32 from a fixed structure may be configured to rigidly resist linear translation of the first and second proof masses in the device plane. In other words, the suspension structures may rigidly resist linear translation in the direction of the x-axis. They may also rigidly resist linear translation in the direction of the y-axis.

Note that the exemplary aspects described above are to facilitate the understanding of the present disclosure and is not intended to limit the present disclosure. The present disclosure can be changed or improved without departing from the spirit of the present disclosure, and the present disclosure includes equivalents thereof. That is, even a modification made by those skilled in the art to the aspects as appropriate is included in the scope of the present disclosure as long as the modification has the features of the present disclosure. In addition, respective elements provided in the aspects can be combined with each other as technically possible, and a combination thereof is also included in the scope of the present disclosure as long as the combination has the features of the present disclosure.

What is claimed:

1. A microelectromechanical device comprising:
a first proof mass and a second proof mass in a device plane; and
a first axis in the device plane, and two fixed stator elements;
wherein the first proof mass lies on a first side of the first axis and comprises a first set of rotor combs, and the first set of rotor combs comprises a first set of rotor transducer combs,
wherein the second proof mass lies on a second side of the first axis and comprises a second set of rotor combs, and the second set of rotor combs comprises a second set of rotor transducer combs, and the first side and the second side of the first axis are opposite to each other,
wherein the two fixed stator elements comprise a first set of stator transducer combs which is interdigitated with the first set of rotor transducer combs, wherein the first set of rotor transducer combs and the first set of stator transducer combs form a first capacitor on the first side of the first axis,
wherein the two fixed stator elements also comprise a second set of stator transducer combs which is interdigitated with the second set of rotor transducer combs, wherein the second set of rotor transducer combs and the second set of stator transducer combs form a second capacitor on the second side of the first axis,
wherein the first proof mass and the second proof mass are configured to undergo an anti-phase movement, wherein the first proof mass moves in a first direction on the first side of the first axis and the second proof mass moves in a second direction on the second side of the first axis, and the first direction is opposite to the second direction, and
wherein the first set of rotor combs further comprise a first set of dummy rotor combs and the second set of rotor combs further comprise a second set of dummy rotor combs, and the first set of rotor combs is reflection-symmetric with the second set of rotor combs in relation to the first axis.

2. The microelectromechanical device according to claim 1, wherein the microelectromechanical device further comprises:
a third proof mass and a fourth proof mass in the device plane,
a second axis in the device plane, and
two additional fixed stator elements,
wherein the second axis is perpendicular to the first axis and crosses the first axis at a crossing point;
wherein the third proof mass lies on a first side of the second axis and comprises a third set of rotor combs, and the third set of rotor combs comprises a third set of rotor transducer combs,
wherein the fourth proof mass lies on a second side of the second axis and comprises a fourth set of rotor combs, and the fourth set of rotor combs comprises a fourth set of rotor transducer combs, and the first side and the second side of the second axis are opposite to each other,
wherein the two additional fixed stator elements comprise a third set of stator transducer combs which is interdigitated with the third set of rotor transducer combs, so that the third set of rotor transducer combs and the third set of stator transducer combs form a third capacitor on the first side of the second axis,
wherein the two additional fixed stator elements comprise a fourth set of stator transducer combs which is interdigitated with the fourth set of rotor transducer combs, so that the fourth set of rotor transducer combs and the fourth set of stator transducer combs form a fourth capacitor on the second side of the second axis,
wherein the third proof mass and the fourth proof mass are configured to undergo the anti-phase movement, wherein the third proof mass moves in a first direction on the first side of the second axis and the fourth proof mass moves in a second direction on the second side of the second axis, and the first direction is opposite to the second direction, and
wherein the third set of rotor combs also comprises a third set of dummy rotor combs and the fourth set of rotor combs also comprises a fourth set of dummy rotor combs, and the first, second, third and fourth proof sets of rotor combs are point-symmetric in relation to the crossing point.

3. The microelectromechanical device according to claim 1, wherein the anti-phase movement is rotation out of the device plane.

4. The microelectromechanical device according to claim 1, wherein the anti-phase movement is linear translation in the device plane.

5. The microelectromechanical device according to claim 1, wherein the microelectromechanical device is a gyroscope.

6. The microelectromechanical device according to claim 1, wherein the microelectromechanical device is an accelerometer.

7. A microelectromechanical device comprising:
a first proof mass and a second proof mass in a device plane;
a third proof mass and a fourth proof mass in the device plane;
a first axis in the device plane and a second axis in the device plane, the second axis is perpendicular to the first axis and crosses the first axis at a crossing point; and
four fixed stator elements,
wherein the first proof mass lies on a first side of the first axis and comprises a first set of rotor combs, and the first set of rotor combs comprises a first set of rotor transducer combs,
wherein the second proof mass lies on a second side of the first axis and comprises a second set of rotor combs, and the second set of rotor combs comprises a second set of rotor transducer combs,
wherein the first side and the second side of the first axis are opposite to each other,
wherein the third proof mass lies on a first side of the second axis and comprises a third set of rotor combs, and the third set of rotor combs comprises a third set of rotor transducer combs,
wherein the fourth proof mass lies on a second side of the second axis and comprises a fourth set of rotor combs, and the fourth set of rotor combs comprises a fourth set of rotor transducer combs,
wherein the first side and the second side of the second axis are opposite to each other,
wherein the first proof mass and the second proof mass are configured to undergo an anti-phase movement, wherein the first proof mass moves in a first direction on the first side of the first axis and the second proof mass moves in a second direction on the second side of the first axis, and the first direction is opposite to the second direction,
wherein the first set of rotor combs further comprise a first set of dummy rotor combs and the second set of rotor combs further comprise a second set of dummy rotor combs, and the first set of rotor combs is reflection-symmetric with the second set of rotor combs in relation to the first axis,
wherein the third proof mass and the fourth proof mass are configured to undergo the anti-phase movement, wherein the third proof mass moves in a first direction on the first side of the second axis and the fourth proof mass moves in a second direction on the second side of the second axis, and the first direction is opposite to the second direction, and
wherein the third set of rotor combs also comprises a third set of dummy rotor combs and the fourth set of rotor combs also comprises a fourth set of dummy rotor combs, and the first, second, third and fourth proof sets of rotor combs are point-symmetric in relation to the crossing point.

8. The microelectromechanical device according to claim 7, wherein the anti-phase movement is rotation out of the device plane.

9. The microelectromechanical device according to claim 7, wherein the anti-phase movement is linear translation in the device plane.

10. The microelectromechanical device according to claim 7, wherein the microelectromechanical device is a gyroscope.

11. The microelectromechanical device according to claim 7, wherein the microelectromechanical device is an accelerometer.
